(19) United States
(12) Patent Application Publication
(10) Pub. No.: US 2015/0368409 A1
(43) Pub. Date: Dec. 24, 2015

(54) METHOD FOR PRODUCING POLYMER POWDERS THAT CAN BE EASILY REDISPERSED IN WATER

(71) Applicant: BASF SE, Ludwigshafen (DE)

(72) Inventors: Joachim PAKUSCH, Speyer (DE); Bogdan MORARU, Ludwigshafen (DE); Jan RUDLOFF, Ludwigshafen (DE); Gary DEETER, Livonia, MI (US); Sebastian EMMERLING, Rheinzabern (DE); Joerg NIEBERLE, Wachenheim (DE); Thomas GOETZ, Leimersheim (DE); Klaus SEIP, Mutterstadt (DE); Gabriele LANG-WITTKOWSKI, Singapore (SG); Kristin SCHMIDT, Bad Salzungen (DE)

(73) Assignee: BASF SE, Ludwigshafen (DE)

(21) Appl. No.: 14/764,294

(22) PCT Filed: Mar. 10, 2014
(86) PCT No.: PCT/EP14/54561

§ 371 Date: Jul. 29, 2015

Related U.S. Application Data
(60) Provisional application No. 61/802,789, filed on Mar. 18, 2013.

(51) Int. Cl. C08J 3/12; C04B 26/06

(52) U.S. Cl. CPC C08J 3/12; C04B 26/06; C08J 2333/08; C08J 2433/02; C08J 2425/14; C08J 2433/12

(57) ABSTRACT

The present invention relates to a process for the preparation of a readily water-redispersible polymer powder by spray drying of an aqueous polymer B dispersion, wherein the spray drying of the aqueous polymer B dispersion is effected in the presence of a polymer A, wherein polymer A has a glass transition temperature ≧60° C., a weight average molecular weight Mw≧1000 and ≦25000 g/mol, a polydispersity index ≦5 and is composed of ≧5 and ≦50 wt % of at least one α,β-monoethylenically un-saturated mono- or dicarboxylic acid and/or anhydride (monomer A1), and ≧50 and ≦95 wt % of at least one other ethylenically un-saturated compound which is copolymerizable with the monomers A1 (monomer A2), in polymerized form, wherein the monomer amounts A1 and A2 sum up to 100 wt %.

The present invention relates to a process for the preparation of a readily water-redispersible polymer powder by spray drying of an aqueous dispersion of a polymer B (aqueous polymer B dispersion), wherein the spray drying of the aqueous polymer B dispersion is effected in the presence of a polymer A, wherein polymer A has a glass transition temperature ≧60° C., a weight average molecular weight Mw≧1000 and ≦25000 g/mol, a polydispersity index ≦5 and is composed of
≧5 and ≦50 wt % of at least one α, β-monoethylenically unsaturated mono- or dicarboxylic acid and/or anhydride (monomer A1), and
≧50 and ≦95 wt % of at least one other ethylenically unsaturated compound which is copolymerizable with the monomers A1 (monomer A2),

in polymerized form, wherein the monomer amounts A1 and A2 sum up to 100 wt %.

The present invention furthermore relates to polymer powders which were prepared by the novel process and the use thereof.

In many applications, polymers which can be incorporated in a simple manner into an aqueous medium are required. In many cases, aqueous dispersions of polymer particles (aqueous polymer dispersions), which can frequently be used directly, are suitable for this purpose. A disadvantage of aqueous polymer dispersions, however, is that they require a water content of up to 60% by weight on storage of large volumes and, when delivered to the customers, water which is economically available everywhere also has to be transported in addition to the desired polymer, adding to the costs. Beside that aqueous polymer dispersions are not freeze-thaw stable, i.e. they have to be protected against low temperatures.

These problems are frequently solved by subjecting the aqueous polymer dispersions, which are obtainable, inter alia, by a free radical aqueous emulsion polymerization familiar to a person skilled in the art, to a spray drying process for the preparation of corresponding polymer powders, which is likewise familiar to a person skilled in the art. With the use of these polymer powders, for example as binders in adhesives, sealing compounds, synthetic resin renders, paper coating slips, surface coating compositions and other coating materials or as additives in mineral binders, the polymer powders generally have to be redispersed in water. This can be effected either by redispersing the polymer powder in water and using the aqueous polymer dispersion obtained for mixing with the other formulation components, or by mixing the polymer powder together with the other formulation components with water. In both cases, it is important that, when brought into contact with water, the polymer powder forms the original polymer particles again rapidly and without formation of agglomerates. The basis for this is the instant behavior of the polymer powder used in water, which is composed of the redispersing behavior and the wetting behavior of the polymer powder.

The redispersing behavior is an important property for the quality of the polymer powder. The better the redispersing behavior of a polymer powder in water, the more closely do the properties of the aqueous polymer dispersion after the redispersing approach the properties of the aqueous polymer dispersion before the spray drying step. In other words, the redispersing behavior of the polymer powder is a measure of the extent to which the original and the redispersed aqueous polymer dispersion correspond in their properties.

If, moreover, the polymer powder also has good wetting behavior, the formation of the aqueous polymer dispersion can also take place without the use of an intensive mixing technique during the redispersing, which has advantages in practice.

While the redispersing behavior of a polymer powder is influenced as a rule substantially by the spray assistants used in the spray drying process, the wetting behavior is determined by the surface characteristics of the polymer powder particle. Said characteristics are frequently determined by the antiblocking agent adhering to the surface of the polymer powder particle.

A person skilled in the art is familiar with a large number of spray assistants in the spray drying of aqueous polymer dispersions. Examples of these are to be found in DE-A 19629525, DE-A 19629526, DE-A 2214410, DE-A 2445813, EP-A 407889 or EP-A 784449.

For cost reasons, spray assistants which are prepared on the basis of economically available raw materials are frequently used. Examples of these are sulfonated phenol or naphthalene/formaldehyde resins, as disclosed, inter alia, in DE-A 19629525 or DE-A 19629526. A disadvantage of these sulfonated phenol or naphthalene/formaldehyde resins is, however, the fact that they may lead to an intense yellow or even brown color of the polymer powders spray-dried with them. These discolorations also present problems in the case of the formulations prepared using these polymer powders, in particular exterior coating formulations, which becomes evident from discolorations of the formulations themselves, which may be further reinforced particularly by sunlight. In many polymer powder applications, for example when they are used as binders or modifiers in mineral renders or in linings of drinking water containers, discoloration of the polymer powder or of the formulations thereof is not desirable.

Mineral binders, such as lime, cement and/or gypsum are typically used together with aggregates comprising sand, gravel, crushed rocks or other fillers such as, for example, natural or synthetic fibers, which by mixing with water are converted to their ready-to-use mortar or concrete form. These aqueous mortar or concrete formulations will, when left alone will harden to a rocklike state over time in air or in some cases even under water. Especially when used as additives in these aqueous mineral binder formulations, redispersible polymer powders being prepared by using the above mentioned sulfonated spray assistants, show negative effects on the flow behavior of the aqueous mortar or concrete formulations. Whereas the presence of the limited amount of spray (drying) assistant generally does not carry through to the mechanical properties of the hardened mortar or concrete modified with a redispersible polymer powder and thus normally does not impair the modifying effect of the redispersed polymer in the hardened mortar or concrete, this does not apply to the flow behavior of the aqueous mortar or concrete formulations (whereas the actual modifying polymer has typically less of an effect on the aforementioned flow behavior). In the case of the aforementioned sulfonated spray assistants the viscosity of the aqueous mortar or concrete formulations is strongly decreased, a behavior which is not desired or favored when the mortar or concrete formulations are to be applied, for example on sloped or vertical substrates.

It is an object of the present invention to provide an improved process for the preparation of polymer powders by spray drying of aqueous polymer dispersions as well as improved polymer powders, which do not or only negligible negatively influence the flow behavior of aqueous mortar or concrete formulations.

It has been found, surprisingly, that this object is achieved by the process defined at the outset.

Aqueous polymer dispersions are generally known. They are fluid systems which comprise, as a disperse phase in an aqueous dispersing medium, polymer particles being composed of polymer coils consisting of a plurality of entangled polymer chains (polymer matrix). The weight average diameter of the polymer particle is frequently from 10 to 1000 nm, often from 50 to 500 nm or from 100 to 400 nm.

Aqueous polymer dispersions are obtainable in particular by free radical aqueous emulsion polymerization of ethylenically unsaturated monomers. This method has been often described in the past and is therefore sufficiently well known to a person skilled in the art [cf. for example Encyclopedia of Polymer Science and Engineering, Vol. 8, pages 659 to 677, John Wiley & Sons, Inc., 1987; D. C. Blackley, Emulsion Polymerisation, pages 155 to 465, Applied Science Publishers, Ltd., Essex, 1975; D. C. Blackley, Polymer Latices, 2nd Edition, Vol. 1, pages 33 to 415, Chapman & Hall, 1997; H. Warson, The Applications of Synthetic Resin Emulsions, pages 49 to 244, Ernest Benn, Ltd., London, 1972; D. Diederich, Chemie in unserer Zeit 24(1990), pages 135 to 142, Verlag Chemie, Weinheim; J. Piirma, Emulsion Polymerisation, pages 1 to 287, Academic Press, 1982; F. Holscher, Dispersionen synthetischer Hochpolymerer, pages 1 to 160, Springer-Verlag, Berlin, 1969, and DE-A 40 03 422]. The free radical aqueous emulsion polymerization is usually effected by a procedure in which the ethylenically unsaturated monomers are dispersed in an aqueous medium, frequently in the presence of dispersants, and are polymerized by means of at least one free radical polymerization initiator. In the aqueous polymer dispersions obtained, the residual contents of unreacted monomers are frequently reduced by chemical and/or physical methods likewise known to a person skilled in the art [cf. for example EP-A 771328, DE-A 19624299, DE-A 19621027, DE-A 19741184, DE-A 19741187, DE-A 19805122, DE-A 19828183, DE-A 19839199, DE-A 19840586 and 19847115], the polymer solids content is brought to a desired value by dilution or concentration, or further conventional additives, for example bactericidal or antifoam additives, are added to the aqueous polymer dispersion. Frequently, the polymer solids contents of the aqueous polymer dispersions are from 30 to 80, from 40 to 70 or from 45 to 65% by weight [wt %].

The novel process can be carried out in particular with aqueous dispersions of a polymer B (aqueous polymer B dispersion) whose polymer comprise
from 50 to 99.9 wt % of esters of acrylic and/or methacrylic acid with alkanols of 1 to 12 carbon atoms and/or styrene, or
from 50 to 99.9 wt % of styrene and butadiene, or
from 50 to 99.9 wt % of vinyl chloride and/or vinylidene chloride, or
from 40 to 99.9 wt % of vinyl acetate, vinyl propionate and/or ethylene

in polymerized form [i.e. incorporated in the form of polymerized units].

According to the invention, it is possible in particular to use those aqueous polymer B dispersions whose polymers comprise
from 0.1 to 5 wt % of at least one α,β-monoethylenically unsaturated mono- and/or dicarboxylic acid of 3 to 6 carbon atoms and/or an amide thereof and
from 50 to 99.9 wt % of esters of acrylic and/or methacrylic acid with alkanols of 1 to 12 carbon atoms and/or styrene, or
from 0.1 to 5 wt % of at least one α,β-monoethylenically unsaturated mono- and/or dicarboxylic acid of 3 to 6 carbon atoms and/or an amide thereof and
from 50 to 99.9 wt % of styrene and butadiene, or
from 0.1 to 5 wt % of at least one α, β-monoethylenically unsaturated mono- and/or dicarboxylic acid of 3 to 6 carbon atoms and/or an amide thereof and
from 50 to 99.9 wt % of vinyl chloride and/or vinylidene chloride, or
from 0.1 to 5 wt % of at least one α,β-monoethylenically unsaturated mono- and/or dicarboxylic acid of 3 to 6 carbon atoms and/or an amide thereof and
from 40 to 99.9 wt % of vinyl acetate, vinyl propionate and/or ethylene

in polymerized form.

According to the present invention, it is possible to use those polymers B whose glass transition temperature is in the range of ≧−60 and ≦150° C., often in the range of ≧−30 and ≦100° C., frequently in the range of ≧−20 and ≦50° C. Most favorably the glass transition temperature of polymer B is in the range of ≧0 and ≦20° C., preferably when polymer B shall be used in repair mortar compositions. The glass transition temperature (T_{g}) means the limit of the glass transition temperature to which said glass transition temperature tends, according to G. Kanig (Kolloid-Zeitschrift & Zeitschrift für Polymere, Vol. 190, page 1, equation 1), with increasing molecular weight. According to the present invention the glass transition temperature is determined by the DSC method (Differential Scanning calorimetry, 20 K/min, midpoint measurement, DIN 53 765).

According to Fox (T. G. Fox, Bull. Am. Phys. Soc. 1 (1956) [Ser. II], page 123 and according to Ullmann's Enzyclopädie der technischen Chemie, Vol. 19, page 18, 4th Edition, Verlag Chemie, Weinheim, 1980), the following is a good approximation for the glass transition temperature of at most weakly crosslinked copolymers B:

1/T_{g}=x¹/T_{g}¹+x²/T_{g}²+ . . . xⁿ/T_{g}ⁿ,

where x¹, x², . . . xⁿ are the mass fractions of the monomers 1, 2, . . . n and T_{g}¹, T_{g}², . . . T_{g}ⁿ are the glass transition temperatures, in degrees Kelvin, of the polymers B composed in each case only of one of the monomers 1, 2, . . . n. The T_{g} values for the homopolymers of most monomers are known and are shown, for example, in Ullmann's Encyclopedia of Industrial Chemistry, 5th Edition, Vol. A21, page 169, Verlag Chemie, Weinheim, 1992; further sources of glass transition temperatures of homopolymers are, for example, J. Brandrup, E. H. Immergut, Polymer Handbook, 1st Ed., J. Wiley, New York, 1966; 2nd Ed. J. Wiley, New York, 1975 and 3rd Ed. J. Wiley, New York, 1989.

According to the present invention the aqueous polymer B dispersion is spray dried in the presence of a polymer A (spray assistant A), wherein polymer A has a glass transition temperature ≧60° C., a weight average molecular weight Mw≧1000 and ≦25000 g/mol, a polydispersity index ≦5 and is composed of
≧5 and ≦50 wt % of at least one α,β-monoethylenically unsaturated mono- or dicarboxylic acid and/or anhydride (monomer A1), and
≧50 and ≦95 wt % of at least one other ethylenically unsaturated compound which is copolymerizable with the monomers A1 (monomer A2),

in polymerized form, wherein the monomer amounts A1 and A2 sum up to 100 wt %.

The polymer A is composed of ≧5 and ≦50 wt %, preferably ≧15 and ≦40 wt % and more preferably ≧15 and ≦30 wt % of at least one α,β-monoethylenically unsaturated mono- or dicarboxylic acid and/or anhydrides thereof (monomers A1) and correspondingly ≧50 and ≦95 wt %, preferably ≧60 and ≦85 wt % and more preferably ≧70 and ≦85 wt % of at least one further monomer (monomers A2), other than the α,β-monoethylenically unsaturated mono- or dicarboxylic acids and/or anhydride in polymerized form. The monomer amounts A1 and A2 sum up to 100 wt %.

The monomers A1 comprise α,β-monoethylenically unsaturated, more particularly C₃ to C₆ and preferably C₃ or C₄ monocarboxylic acids or C₄ to C₆ and preferably C₄ and C₅ dicarboxylic acids and/or anhydrides thereof as well as their fully or partially neutralized salts, more particularly their alkali metal or ammonium salts, for example acrylic acid, methacrylic acid, ethylacrylic acid, itaconic acid, allylacetic acid, crotonic acid, vinylacetic acid, fumaric acid, maleic acid, 2-methylmaleic acid, but also monoesters of ethylenically unsaturated dicarboxylic acids, such as monoalkyl esters of maleic acid with C₁ to C₈ alcohols, and also the ammonium, sodium or potassium salts of the aforementioned acids. But the monomers A1 also comprise the anhydrides of corresponding α,β-monoethylenically unsaturated dicarboxylic acids, for example maleic anhydride or 2-methylmaleic anhydride. Preferably, monomer A1 is selected from the group comprising acrylic acid, methacrylic acid, crotonic acid, fumaric acid, maleic acid, maleic anhydride, 2-methylmaleic acid and itaconic acid, of which acrylic acid, methacrylic acid, maleic acid, maleic anhydride and/or itaconic acid are particularly preferred. Mostly preferred are acrylic acid and/or methacrylic acid.

Useful monomers A2 include all ethylenically unsaturated monomers that differ from the monomers A1 and are copolymerizable therewith. Useful monomers A2 include, for example, vinylaromatic compounds, such as styrene, α-methylstyrene, o-chlorostyrene or vinyltoluenes, vinyl halides, such as vinyl chloride or vinylidene chloride, esters of vinyl alcohol and C₁ to C₁₈ and preferably C₂ to C₁₂ monocarboxylic acids, such as vinyl acetate, vinyl propionate, vinyl n-butyrate, vinyl laurate and vinyl stearate, C₁ to C₁₂ alkyl vinyl ethers, such as methyl vinyl ether, ethyl vinyl ether, n-propyl vinyl ether, n-butyl vinyl ether, n-pentyl vinyl ether, n-hexyl vinyl ether, esters of preferably C₃ to C₆ α,β-monoethylenically unsaturated mono- and dicarboxylic acids, more particularly acrylic acid, methacrylic acid, maleic acid, fumaric acid and itaconic acid with generally C₁ to C_{12,} preferably C₁ to C₈ and more particularly C₁ to C₄ alkanols, particularly methyl acrylate, ethyl acrylate, n-butyl acrylate, isobutyl acrylate, pentyl acrylate, hexyl acrylate, heptyl acrylate, octyl acrylate, nonyl acrylate, decyl acrylate, 2-ethylhexyl acrylate, methyl methacrylate, ethyl methacrylate, n-butyl methacrylate, isobutyl methacrylate, pentyl methacrylate, hexyl methacrylate, heptyl methacrylate, octyl methacrylate, nonyl methacrylate, decyl methacrylate, 2-ethylhexyl methacrylate, dimethyl fumarate, di-n-butyl fumarate, dimethyl maleate, di-n-butyl maleate, nitriles of α,β-monoethylenically unsaturated carboxylic acids, such as acrylonitrile, methacrylonitrile, fumaronitrile, maleonitrile and also C₄₋₈ conjugated dienes, such as 1,3-butadiene (butadiene) and isoprene. The aforementioned monomers are generally ≧50 wt %, preferably ≧80 wt % and more preferably ≧90 wt % of the total amount of all monomers A2 and thus constitute the main monomers A2.

Preferred monomers A2 are vinylaromatic monomers, C₁ to C₄ alkyl methacrylates, and ethylenically unsaturated nitrile compounds. Vinylaromatic monomers are understood to include in particular derivatives of styrene or of α-methylstyrene in which the phenyl rings are substituted optionally by 1, 2 or 3 C₁ to C4 alkyl groups, halogen, more particularly bromine or chlorine, and/or methoxy groups. The ethylenically unsaturated nitrile compounds are essentially the nitriles which derive from the aforementioned α,β-monoethylenically unsaturated, especially C₃ to C_{6,} preferably C₃ to C_{4,} monocarboxylic or dicarboxylic acids, such as, for example, acrylonitrile, methacrylonitrile, maleonitrile and/or fumaronitrile, with acrylonitrile and/or methacrylonitrile being particularly preferred. Preferred monomers A2 are those whose homopolymers have a glass transition temperature of ≧80 ° C. Particularly preferred monomers A2 are styrene, α-methylstyrene, o- or p-vinyltoluene, p-acetoxystyrene, p-bromostyrene, p-tert-butylstyrene, o-, m- or p-chlorostyrene, methyl methacrylate, n-butyl acrylate, 2-ethylhexyl acrylate, tert-butyl acrylate, tert-butyl methacrylate, ethyl methacrylate, isobutyl methacrylate, n-hexyl acrylate, cyclohexyl methacrylate, acrylonitrile, methacrylonitrile, but also, for example, tert-butyl vinyl ether or cyclohexyl vinyl ether, but with methyl methacrylate, styrene, α-methylstyrene and/or tert-butyl methacrylate being especially preferred. However, most preferred are styrene and/or α-methylstyrene.

Useful monomers A2 further include a minor proportion of such ethylenically unsaturated monomers that comprise at least one amino, amido, ureido or N-heterocyclic group and/or the ammonium derivatives thereof that are alkylated or protonated at the nitrogen. Examples are acrylamide and methacrylamide, moreover also N-vinylpyrrolidone, 2-vinylpyridine, 4-vinylpyridine, 2-vinylimidazole, 2-(N,N-dimethylamino)ethyl acrylate, 2-(N,N-dimethylamino)ethyl methacrylate, 2-(N,N-diethylamino)ethyl acrylate, 2-(N,N-diethylamino)ethyl methacrylate, 2-(N-tert-butylamino)ethyl methacrylate, N-(3-N′,N′-dimethylaminopropyl)methacrylamide and 2-(1-imidazolin-2-onyl)ethyl methacrylate. The aforementioned monomers A2 are generally used in amounts ≦10 wt %, preferably ≦5 wt % and more preferably ≦1 wt %, all based on the total amount of monomers A2. Preferably, however, no such monomers A2 are used.

Monomers A2 which typically enhance the integrity of films formed by a polymer matrix normally comprise at least one epoxy group, at least one carbonyl group or at least two nonconjugated ethylenically unsaturated double bonds. Examples thereof are monomers comprising two vinyl radicals, monomers comprising two vinylidene radicals and also monomers comprising two alkenyl radicals. Of particular advantage here are the diesters of dihydric alcohols with α, β-monoethylenically unsaturated monocarboxylic acids, among which acrylic acid and methacrylic acid are preferred. Examples of such monomers comprising two nonconjugated ethylenically unsaturated double bonds are alkylene glycol diacrylates and dimethacrylates, such as ethylene glycol diacrylate, 1,2-propylene glycol diacrylate, 1,3-propylene glycol diacrylate, 1,3-butylene glycol diacrylate, 1,4-butylene glycol diacrylate and ethylene glycol dimethacrylate, 1,2-propylene glycol dimethacrylate, 1,3-propylene glycol dimethacrylate, 1,3-butylene glycol dimethacrylate, 1,4-butylene glycol dimethacrylate and also divinylbenzene, vinyl methacrylate, vinyl acrylate, allyl methacrylate, allyl acrylate, diallyl maleate, diallyl fumarate, methylenebisacrylamide, cyclopentadienyl acrylate, triallyl cyanurate or triallyl isocyanurate. The aforementioned monomers A2 are generally used in amounts ≦10 wt %, preferably ≦5 wt % and more preferably ≦1 wt %, all based on the total amount of monomers A2. Preferably, however, no such monomers A2 are used.

However, acrylic acid and/or methacrylic acid as monomer A1 and methyl methacrylate, n-butyl acrylate, 2-ethylhexyl acrylate, styrene and/or a-methyl styrene as monomer A2 are most preferred.

In a preferred embodiment polymer A is composed of
≧15 and ≦40 wt % of at least one monomer A1 selected from the group comprising acrylic acid, methacrylic acid, crotonic acid, fumaric acid, maleic acid, maleic anhydride, 2-methylmaleic acid and itaconic acid, and
≧60 and ≦85 wt % of at least one monomer A2 selected form the group consisting of styrene, α-methyl styrene, o- or p-vinyltoluene, p-acetoxystyrene, p-bromostyrene, p-tert-butylstyrene, o-, m- or p-chlorostyrene, methyl methacrylate, n-butyl acrylate, 2-ethylhexyl acrylate, tert-butyl acrylate, tert-butyl methacrylate, ethyl methacrylate, isobutyl methacrylate, n-hexyl acrylate, cyclohexyl methacrylate, acrylonitrile, methacrylonitrile, tert-butyl vinyl ether or cyclohexyl vinyl ether,

and more preferably of
≧15 and ≦30 wt % of at least one monomer A1 selected from the group comprising acrylic acid, methacrylic acid, crotonic acid, fumaric acid, maleic acid, maleic anhydride, 2-methylmaleic acid and itaconic acid, and
≧70 and ≦85 wt % of at least one monomer A2 selected form the group consisting of styrene, α-methyl styrene, o- or p-vinyltoluene, p-acetoxystyrene, p-bromostyrene, p-tert-butylstyrene, o-, m- or p-chlorostyrene, methyl methacrylate, n-butyl acrylate, 2-ethylhexyl acrylate, tert-butyl acrylate, tert-butyl methacrylate, ethyl methacrylate, isobutyl methacrylate, n-hexyl acrylate, cyclohexyl methacrylate, acrylonitrile, methacrylonitrile, tert-butyl vinyl ether or cyclohexyl vinyl ether,

in polymerized form.

In a more preferred embodiment polymer A is composed of
≧15 and ≦40 wt % of acrylic acid and/or methacrylic acid, and
≧60 and ≦85 wt % of methyl methacrylate, n-butyl acrylate, 2-ethylhexyl acrylate, styrene and/or α-methyl styrene

and advantageously of
≧15 and ≦30 wt % of acrylic acid and/or methacrylic acid, and
≧70 and ≦85 wt % of methyl methacrylate, n-butyl acrylate, 2-ethylhexyl acrylate, styrene and/or α-methyl styrene

in polymerized form.

Polymer A according to the present invention shows a glass transition temperature ≧60° C., preferably ≧80 and ≦130° C. and most preferably ≧80 and ≦110° C. The glass transition temperature of polymer A is also determined by the DSC method (Differential Scanning Calorimetry, 20 K/min, midpoint measurement, DIN 53 765). Therefore, the monomers A1 and A2 have to be chosen in type and amount such, that polymers A according to the present invention are obtained.

The weight average molecular weight Mw of polymer A is in the range of ≧1000 and ≦25000 g/mol, preferably ≧7500 and ≦22500 g/mol and most preferably ≧10000 and ≦20000 g/mol. Determining the weight average molecular weight is familiar to a person skilled in the art and is effected more particularly by gel permeation chromatography using standard polymers of defined molecular weight.

The polymers A according to the present invention featuring a polydispersity index of ≦5 and preferably ≧2.5 and ≦4.5 and most preferably ≧3.0 and ≦4.0. The polydispersity index (PDI) is a measure of the distribution of molecular mass in a given polymer. The PDI is calculated by the weight average molecular weight divided by the number average molecular weight Mn of a given polymer (PDI=Mw/Mn). The more the PDI of a given polymer approaches the value of 1, the more the polymer chain lengths become uniform. The PDI according to the present invention is also determined by means of gel permeation chromatographie with defined standards.

The acid number of the polymers A is preferably in the range ≧50 and ≦300, favorably in the range ≧100 and ≦230 and most favorably in the range ≧150 and ≦230 mg KOH per gram polymer, whereas the acid number is defined as the mass of potassium hydroxide (KOH) in milligrams that is required to neutralize one gram of polymer A. Within the framework of the present invention the acid number is measured according to DIN EN ISO 2114.

Polymers A and their preparation are familiar to a person skilled in the art. The preparation of polymers A is favorably carried out by continuous high temperature free-radical polymerization of monomers A1 and A2 according to the methods of bulk or specific solution polymerization in continuous stirred tank reactor at temperatures in the range ≧180 and ≦310° C. (see e.g. U.S. Pat. No. 4,013,607, U.S. Pat. No. 4,414,370, U.S. Pat. No. 529,787, U.S. Pat. No. 4,546,160).

The polymer A as spray assistant A can be applied directly in the form of powder or in the form of an aqueous suspension or solution. Preferably polymer A is applied in the form of an aqueous suspension or solution. Within the framework of this invention the polymer A can also be applied in the acidic, partially neutralized or fully neutralized form. Preferably the polymer A is applied in the partially or fully neutralized form. The partial or full neutralization of the carboxylic acid groups of polymer A is effected by common and known bases, such as alkali metal hydroxide, such as sodium hydroxide or potassium hydroxide, alkaline earth metal, such as calcium hydroxide or ammonia, amines, such as diethanolamine, triethanolamine or ethylenediamine. Preferably the partial and most preferably the full neutralized polymer A are applied. Sodium hydroxide and/or potassium hydroxide are used most preferably for the neutralization of polymer A.

Most favorably the polymer A is used in the form of an aqueous suspension or solution having a pH value of ≧7 and ≦10 and preferably ≧7 and ≦9, measured at 20 to 25° C. (room temperature) using a calibrated pH meter.

In a preferred embodiment the pH value of the aqueous suspension or solution of polymer A and the pH value of the aqueous polymer B dispersion differ by a value ≦0.5 preferably ≦0.3 and most preferably ≦0.1.

The preparation of the aqueous polymer A suspension or solution is preferably carried out by adding polymer A to the aqueous solution of a base, whereas the amount of the base has been calculated on the basis of the acid number and the intended degree of neutralization of polymer A. Usually the dissolving or dispersing process is carried out at room temperature or preferably at temperatures in the range of ≧60 and ≦80° C. In case polymer A has been prepared by a solution polymerization process, the solvent has to be removed by methods known to the person skilled in the art before the dissolving or dispersing process is carried out.

The fact that polymer A (both in the form of its aqueous solution or suspension and in the form of a solid powder) can be used as a mixture with at least one other spray assistant X (likewise in the form of the aqueous solution, aqueous suspension or as a solid powder) differing from the polymer A is important. Advantageously, the total amount of the spray assistant comprises ≧50, ≧60, ≧70, ≧80 or ≧90 and frequently even 100 wt % of polymer A.

For example, the spray assistants disclosed in the prior art mentioned below, also referred to as drying assistants, can be used as spray assistant X. Thus, DE-A 2049114 recommends adding condensates of melaminesulfonic acid and formaldehyde as spray assistants to aqueous polymer dispersions. DE-A 2445813 and EP-A 78449 recommend adding condensates of naphthalenesulfonic acid and formaldehyde (in particular the water-soluble alkali metal and/or alkaline earth metal salts thereof) as drying assistants to aqueous polymer dispersions. EP-A 407889 recommends adding condensates of phenolsulfonic acid and formaldehyde (in particular the water-soluble alkali metal and/or alkaline earth metal salts thereof) as drying assistants to aqueous polymer dispersions. DE-B 2238903 and EP-A 576844 recommend the use of poly-N-vinylpyrrolidone as such a spray assistant. EP-A 62106 and EP-A 601518 recommend the use of polyvinyl alcohol as a drying assistant. Polyvinyl alcohol is also recommended by U. Rietz in Chemie and Technologie makromolekularer Stoffe (FH-texts FH Aachen) 53 (1987) 85 and in EP-A 680993 and in EP-A 627450 as a drying assistant. Ligninsulfonates are mentioned as drying assistants in DE-A 3344242. DE-A 19539460, EP-A 671435 and EP-A 629650 disclose homo- and copolymers of 2-acrylamido-2-methylpropanesulfonic acid as suitable drying assistants for aqueous polymer dispersions. EP-A 467103 relates to the preparation of polymer powders, redispersible in an aqueous medium, by drying with addition of copolymers of from 50 to 80 mol % of an olefinically unsaturated mono- and/or dicarboxylic acid and from 20 to 50 mol % of a C₃-to C₁₂-alkene and/or styrene as drying assistants. DE-A 2445813 recommends condensates containing sulfone groups and comprising mononuclear or polynuclear aromatic hydrocarbons and formaldehyde as drying assistants. In DE-A 4406822, graft polymers of polyalkylene oxides and unsaturated mono- and/or dicarboxylic acids or the anhydrides thereof, after derivatization with primary/secondary amines or alcohols, are recommended as drying assistants. DE-A 3344242 and EP-A 536597 mention starch and starch derivatives as suitable drying assistants. In DE-A 493168, organopolysiloxanes are recommended as drying assistants. DE-A 3342242 furthermore mentions cellulose derivatives as suitable drying assistants and DE-A 4118007 recommends condensates of sulfonated phenols, urea, further organic nitrogen bases and formaldehyde as drying assistants.

The total amount of polymer A (calculated as solid) which is added to the aqueous polymer B dispersion before or during, in particular however before, the spray drying is from 0.1 to 40, preferably from 1 to 25 and most preferably from 5 to 20, parts by weight, based in each case on 100 parts by weight of the polymer B.

Therefore, the use of a polymer A, which has a glass transition temperature 60° C., a weight average molecular weight Mw≧1000 and ≦25000 g/mol, a polydispersity index ≦5 and is composed of

≧5 and ≦50 wt % of at least one monomer A1 , and

≧50 and ≦95 wt % of at least one monomer A2,

in polymerized form, wherein the monomer amounts A1 and A2 sum up to 100 wt %, as a spray assistant in the spray drying of aqueous polymer dispersions is also an embodiment of the present invention.

According to TIZ-Fachberichte, Vol. 109, No. 9, 1985, page 698 et seq., the spray assistants usually used are as a rule water-soluble substances which, on spray drying of the aqueous polymer dispersion to give the polymer powder, form a matrix into which the water-insoluble primary polymer particles surrounded by dispersant are embedded. The matrix surrounding and protecting the primary polymer particles counteracts irreversible formation of secondary particles. Thus, reversible formation of secondary particles (agglomerates having a size of, typically, from 1 to 250 μm), which comprise numerous primary polymer particles separated from one another by the spray assistant matrix, generally takes place. When the polymer powders obtained according to the invention are redispersed with water, the matrix dissolves again and the original primary polymer particles surrounded by dispersant are substantially obtained again. Advantageously, finely divided antiblocking agents are also added to the secondary particles reversibly formed in the form of polymer powder, which antiblocking agents act as spacers and, for example, counteract their caking on storage of the polymer powder under the action of the pressure imposed by its own weight, it being possible to effect this addition of antiblocking agent before, during and/or after the spray drying.

The antiblocking agents are as a rule powders of inorganic solids, having a mean particle size of from 0.1 to 20 μm, frequently from 1 to 10 μm (based on ASTM C 690-1992, Multisizer/100 μm capillary). It is advantageous if the inorganic substances have a solubility of ≦50, preferably ≦10 and more preferably ≦5 g/l in water at 20° C.

Silicas, aluminum silicates, carbonates, for example calcium carbonate, magnesium carbonate or dolomite, sulfates, for example barium sulfate, and talcs, calcium sulfate, cements, dolomite, calcium silicates or diatomaceous earth may be mentioned by way of example. Mixtures of the abovementioned compounds, for example microintergrowths of silicates and carbonates, are also suitable.

Depending on their surface characteristics, the antiblocking agents may have hydrophobic (water-repellent) or hydrophilic (water-attracting) properties. A measure of the hydrophobicity or hydrophilicity of a substance is the contact angle of a drop of demineralized water on a compact of the corresponding antiblocking agent. The larger the contact angle of the water drop on the surface of the compact, the greater is the hydrophobicity or the lower is the hydrophilicity, and vice versa. In order to decide whether one antiblocking agent is more hydrophobic or more hydrophilic than another, standard sieve fractions (=identical particle sizes or particle size distributions) of both antiblocking agents are produced. Compacts having level surfaces are produced from these sieve fractions of identical sizes or size distributions under identical conditions (amount, area, compression pressure, temperature). A water drop is applied by means of a pipette to each compact and immediately thereafter the contact angle between compact surface and water drop is determined. The larger the contact angle between compact surface and water drop, the greater is the hydrophobicity or the lower is the hydrophilicity. Frequently, both hydrophobic and hydrophilic antiblocking agents are used. It may be advantageous if the spray drying of the aqueous polymer dispersion is effected in the presence of a hydrophobic antiblocking agent and the resulting polymer powder is homogeneously mixed with a hydrophilic antiblocking agent in a subsequent step.

In the context of this document, hydrophilic antiblocking agents are understood as meaning those antiblocking agents which are more hydrophilic than the hydrophobic antiblocking agents used, i.e. their contact angles are smaller than those of the hydrophobic antiblocking agents used in the spraying process.

Frequently, the hydrophobic antiblocking agents have a contact angle of ≧90°, ≧100° or ≧110°, while the hydrophilic antiblocking agents have a contact angle of <90°, ≦80° or ≦70°. It is advantageous if the contact angles of the hydrophobic and hydrophilic antiblocking agents used differ by ≧10°, ≧20°, ≧30°, ≧40°, ≧50°, ≧60°, ≧70°, ≧80° or ≧90°.

Hydrophilic antiblocking agents used are, for example, silicas, quartz, dolomite, calcium carbonate, sodium/aluminum silicates, calcium silicates or microintergrowths of silicates and carbonates, and hydrophobic antiblocking agents used are, for example, talc (magnesium hydrosilicate having a sheet structure), chlorite (magnesium/aluminum/iron hydrosilicate), silicas treated with organochlorosilanes (DE-A 3101413) or generally hydrophilic antiblocking agents which are coated with hydrophobic compounds, for example precipitated calcium carbonate coated with calcium stearate.

It is advantageous if from 0.001 to 10 parts by weight and often from 0.1 to 1 part by weight of a hydrophobic antiblocking agent and from 0.01 to 30 parts by weight and often from 1 to 10 parts by weight of a hydrophilic antiblocking agent are used per 100 parts by weight of the polymer B present in the aqueous polymer dispersion. It is particularly advantageous if the ratio of the hydrophobic antiblocking agent to the hydrophilic antiblocking agent is 0.001 to 0.25: 1 and especially 0.004 to 0.08: 1.

Optimum results are obtained, when aqueous dispersions of a polymer B having a weight average particle size of from 50 to 1000 nm, particularly from 100 to 500 nm (d₅₀ values, determined using an analytical ultracentrifuge [cf. S. E. Harding et al., Analytical Ultracentrifugation in Biochemistry and Polymer Science, Royal Society of Chemistry, Cambridge, Great Britain 1992, Chapter 10, Analysis of Polymer Dispersions with an Eight-Cell-AUC-Multiplexer: High Resolution Particle Size Distribution and Density Gradient Techniques, W. Mächtle, pages 147 to 175]), are used and the ratio of the mean secondary particle diameter (mean polymer powder diameter; after the spray-drying, frequently from 10 to 150 μm, often from 50 to 100 μm, determined on the basis of ASTM C 690-1992, Multisizer/100 μm capillary) to the mean particle diameter of the hydrophobic and/or the hydrophilic antiblocking agents is 1 to 50:1 or 5 to 30:1.

The spray drying known to a person skilled in the art is effected in a drying tower with the aid of atomizer disks or airless high-pressure nozzles or binary nozzles in the top of the tower. The drying of the aqueous polymer B dispersion with prior addition of the polymer A and optionally at least one further spray assistant X is carried out using a hot gas, for example nitrogen or air, which is blown into the tower from below or above, but preferably from above cocurrent with the material to be dried. The temperature of the drying gas at the tower entrance is from about 90 to 180° C., preferably from 110 to 160° C., and that at the tower exit is from about 50 to 90° C., preferably from 60 to 80° C. The hydrophobic antiblocking agent is frequently introduced into the drying tower simultaneously with the aqueous polymer B dispersion but spatially separately therefrom. The addition is effected, for example, via a binary nozzle or conveying screw, in the form of a mixture with the drying gas or via a separate orifice. However, it is important to understand, that the present invention shall also comprise the addition of polymer A simultaneously to the aqueous polymer B dispersion into the drying tower but spatially separately therefrom.

The polymer powder discharged from the drying tower is cooled to 20 to 30° C. and frequently mixed with a hydrophilic antiblocking agent in commercial mixers, for example a Nauta mixer, as supplied by numerous companies.

The polymer powders obtainable according to the invention can be used in particular as binders in adhesives, sealing compounds, synthetic resin renders, paper coating slips, surface coating compositions and other coating materials or preferably as an additive in mineral binder formulations.

The polymer powders obtained according to the invention can also be redispersed in a simple manner in water, the primary polymer particles substantially being obtained again.

The polymer powders obtained according to the invention have a very good shelf-life and flowability. They produce little dust and can be redispersed in a simple manner in water without a great mixing effort. The polymer powders obtained are particularly suitable for use as binders in adhesives, sealing compounds, synthetic resin renders, paper coating slips, surface coating compositions and other coating materials or preferably as additives in mineral binder formulations. The fact that the polymer powders obtained are virtually colorless and furthermore no undesired discolorations occur when they are used as binders or as additives is moreover important. Furthermore, the inventive polymer powders can be favorably added to dry mortar or concrete formulations to result in stable and durable modified dry mortar or concrete formulations. In addition, when these modified dry mortar or concrete formulations are admixed with water or when aqueous mortar or concrete formulations are admixed with the inventive polymer powders modified aqueous mortar or concrete formulations are obtained, which do show no or only minimal decrease of the modified aqueous mortar or concrete formulation viscosity.

### EXAMPLES

1 Preparation of an Aqueous Polymer Dispersion D

In a polymerization reactor,
362.3 g of a polystyrene seed dispersion having a polymer solids content of 0.21 wt % and a weight average particle diameter of 30 nm (d₅₀ value, determined by means of an analytical ultracentrifuge)

were heated to 90° C. with stirring and under a nitrogen atmosphere. Thereafter, a solution consisting of 0.9 g sodium peroxodisulfate and 11.6 g demineralized water was added in one shot. After 5 minutes, beginning at the same time and while maintaining the internal temperature of 90° C., an aqueous monomer emulsion consisting of
735.0 g of n-butyl acrylate,
731.3 g of styrene,
60.0 g of a 50 wt % aqueous solution of acrylamide,
3.8 g of acrylic acid,
225.0 g of a 20 wt % aqueous solution of an alkylpolyethylene glycol ether based on a saturated C₁₆₋₁₈-fatty alcohol (ethylene oxide [EO] degree 18),
24.8 g of a 32 wt % aqueous solution of a sodium salt of a C₁₆₋₁₈-fatty alcohol poly glycol ether sulfate (EO degree 18) and
357.5 g of demineralized water

and a solution consisting of 8.1 g of sodium peroxodisulfate and 108 g of demineralized water were added continuously to this mixture in 3 hours and 15 minutes. Thereafter, the reaction mixture was cooled to 85° C. After addition of a solution of 3 g of tert-butyl hydroperoxide in 27 g of demineralized water in one shot, a solution of 4.5 g of sodium bisulfite in 29.8 g of demineralized water was added at this temperature in the course of 2 hours. Thereafter, cooling to 20 to 25° C. (room temperature) was effected and a pH of 7.5 was established with a 10 wt % aqueous sodium hydroxide solution. A polymer dispersion having a solids content of 55.1 wt % was obtained. The glass transition temperature (DSC midpoint) of the polymer was 16° C.

The glass transition temperature was determined by the DSC method (Differential Scanning Calorimetry, 20k/min, midpoint measurement, DIN 53 765).

The solids contents were generally determined by drying an aliquot amount of the aqueous polymer dispersion or of the aqueous spray assistant solution at 130° C. in a drying oven to constant weight.

Thereafter the aqueous polymer dispersions D has been diluted with demineralized water to a solids content of 48.7 wt %.

2 Preparation of the Spray Assistants

2.1 Inventive Spray Assistants S1 to S6

The preparation of the spray assistants S1 to S6 were effected according to the teachings of U.S. Pat. No. 4,414,370, U.S. Pat. No. 4,529,787, U.S. Pat. No. 4,546,160, U.S. Pat. No. 6552144, U.S. Pat. No. 6,605,681, U.S. Pat. No. 6,984,694.

A reaction mixture of monomers, solvents and initiator were continuously supplied to a continuous stirred tank reactor (CSTR) maintained at a constant temperature. Reaction zone mass and feed mass flow rate were controlled to provide a constant average residence time within a desired range typically between 10 to 35 minutes in the CSTR. The reaction temperatures of the CSTR were maintained constant at different settings typically within the range of 160 to 230° C. The reaction products S1 to S6 were continuously pumped through a devolatilization zone (wiped film evaporator) and thereafter continuously collected. Specific monomer feed compositions, reaction conditions and characteristics of the polymers S1 to S6 are given in table 1.

TABLE 1
Specific monomer feed compositions, reaction conditions and characteristics of
the polymers S1 to S6

| | Polymers | | | | | |
|---|---|---|---|---|---|---|
| | S1 | S2 | S3 | S4 | S5 | S6 |
| Feed [wt %] | | | | | | |
| Acrylic acid | 27.3 | 29.7 | 27.9 | 12.0 | 8.4 | — |
| Styrene | 23.7 | 48.6 | 45.6 | 39.7 | 19.9 | 39.8 |
| α-Methyl styrene | 18.2 | 12.8 | — | — | — | 24.6 |
| Methyl methacrylate | 15.5 | — | — | 17.2 | 46.5 | — |
| n-Butyl acrylate | 6.4 | — | — | — | 9.2 | — |
| Methacrylic acid | — | — | — | 8.7 | — | 25.1 |
| 2-Ethyl hexyl acrylate | — | — | — | 22.3 | — | — |
| Di-tert butyl peroxide | 0.1 | 0.1 | 1.9 | 0.1 | 0.2 | 0.5 |
| Carbitol¹⁾ | — | 5.4 | 24.6 | — | — | 10.0 |
| Aromatic 100²⁾ | 8.8 | — | — | — | — | — |
| DM Water³⁾ | — | 3.4 | — | — | — | — |
| Isopropyl alcohol | — | — | — | — | 15.8 | — |
| Reaction Conditions | | | | | | |
| Temperature [° C.] | 210 | 225 | 170 | 200 | 190 | 210 |
| Pressure [bar] | 27.6 | 27.6 | 27.6 | 27.6 | 27.6 | 20.0 |
| Residence Time [min] | 12 | 12 | 30 | 12 | 12 | 12 |
| Evaporation Conditions | | | | | | |
| Temperature [° C.] | 240 | 240 | 240 | 240 | 240 | 240 |
| Pressure [mbar absolute] | 240 | 140 | 270 | 210 | 100 | 520 |
| Polymer Properties | | | | | | |
| Mn [g/mol] | 4600 | 3900 | 3500 | 4200 | 4600 | 3300 |
| Mw [g/mol] | 18500 | 12900 | 13300 | 15500 | 13900 | 10200 |
| PDI | 4.0 | 3.3 | 3.8 | 3.7 | 3.0 | 3.1 |
| Acid Number [mg KOH per | 210 | 215 | 194 | 125 | 55 | 135 |
| gram polymer] | | | | | | |

¹⁾Trademark of Dow Chemical Company, Diethylene glycol monoethyl ether
²⁾Trademark of ExxonMobile Chemical, C₉-C₁₀ di- and trialkylbenzenes
³⁾demineralized water

2.2 Neutralization of the Spray Assistance S1 to S6

A 2.5 L vessel equipped with a condenser and mechanical stirrer was charged at room temperature under agitation with the amounts of deionized water and solid sodium hydroxide as given in table 2. Once the sodium hydroxide was completely dissolved, the temperature was increased to 65° C. At that temperature the amounts of the polymers S1 to S6 also given in table 2 were charged in small portions to the aqueous NaOH-solution within one hour. Agitation was continued until homogenous, clear and slightly viscous solutions were obtained. The obtained polymer solutions were cooled down to room temperature. Generally pH values ≧7.0 and ≦5 7.5 were obtained.

TABLE 2
Aqueous solutions of the neutralized polymers S1 to S6.

| Amounts [g] | S1 | S2 | S3 | S4 | S5 | S6 |
|---|---|---|---|---|---|---|
| Polymer | 225 | 225 | 225 | 225 | 225 | 225 |
| NaOH (solid) | 35 | 36 | 33 | 21 | 9 | 19 |
| DM Water | 740 | 739 | 742 | 754 | 766 | 756 |

2.3 Comparative Spray Assistant SV1

The preparation of the comparative spray assistant SV1 was conducted analogously to example 1 of DE-A 19629525.

1.2 kg of naphthalene were initially taken at 85° C. in a reactor, and 1.2 kg of a 98 wt % sulfuric acid were slowly added with stirring and cooling so that the temperature of the reaction mixture was always below 150° C. After the end of the sulfuric acid addition, the reaction mixture was allowed to continue reacting for 5 hours at 150° C. Thereafter, the reaction mixture was cooled to 50° C. and, while maintaining a temperature of from 50 to 55° C., 0.8 kg of a 30 wt % aqueous solution of formaldehyde was added a little at a time. After the end of the addition, 0.7 kg of demineralized water was immediately added to the reaction mixture and the latter was heated to 100° C. and allowed to continue reacting for 5 hours with further stirring at this temperature. Thereafter, the reaction mixture was cooled to 65° C. and a 35 wt % aqueous slurry of calcium hydroxide was added until a pH of 7.5 was reached. Thereafter, the aqueous reaction mixture was filtered over a 200 μm sieve and an aqueous solution of the comparative spray assistant SV2 having a solids content of about 35 wt % was obtained.

The aqueous solution of the spray assistant SV1 was then diluted with demineralized water to a polymeric solids content of 22.5 wt %.

3 Spray Drying

3.1 Antiblocking Agent

The hydrophobic antiblocking agent used was Sipernat® D 17 from Evonik. This is a precipitated silica having a specific surface area (based on ISO 5794-1, Annex D) of 100 m²/g, a mean particle size (based on ISO 13320-1) of 10 μm and a tamped density (based on ISO 787-11) of 150 g/l, whose surface was rendered water repellent by treatment with special chlorosilanes.

3.2 Preparation of the Spray-Dried Polymer Powders

The preparation of the spray feed was effected by adding, at room temperature, 1 part by weight of the 22.5 wt % aqueous solutions of the neutralized polymers S1 to S6 or SV1 to 5 parts by weight of the aqueous polymer dispersion D and mixing homogeneously with stirring.

The spray drying was effected in a Minor laboratory dryer from GEA Wiegand GmbH (Business Area Niro) with binary nozzle atomization and powder deposition in a fabric filter. The tower entrance temperature of the nitrogen was 135° C. and the exit temperature was 65° C. 2 kg of a spray feed per hour were metered in.

Simultaneously with the spray feed, 2% by weight, based on the solids content of the spray feed, of the hydrophobic antiblocking agent Sipernat® D 17 were metered continuously via a weight-controlled twin screw into the side of the spray tower.

Novel polymer powders PS1 to PS6 were obtained from the aqueous polymer dispersions D by using the spray assistants S1 to S6. The comparative polymer powder PSV1 was obtained from the aqueous polymer dispersion D by using the comparative spray assistant SV1. The powder yields obtained in the spray drying are shown in table 3.

4 Assessment of the Spray-Dried Polymer Powders

4.1 Redispersibility in Water

30 g of each of the polymer powders PS1 to PS6 and PSV1 obtained were homogeneously mixed at room temperature in a standing cylinder with 70 ml of demineralized water by means of an Ultra Turrax apparatus at 9500 revolutions per minute. Thereafter, the aqueous polymer dispersions obtained were allowed to stand for 4 hours at room temperature, after which a visual assessment was performed to determine the extent to which the polymer phases had separated in the aqueous phases. If no phase separation at all was observed, the redispersibility was rated as good. If phase separation was observed, the redispersibility was rated as poor. The results are also summarized in table 3.

4.2 Visual Assessment

The color of the polymer powders PS1 to PS6 and PSV1 obtained was assessed visually. The results obtained are also shown in table 3.

TABLE 3
Spray drying yields and assessment of the spray-dried polymer powders

| Polymer powder | Yield [wt %] | Color | Redispersibility |
|---|---|---|---|
| PS1 | 87 | white | good |
| PS2 | 87 | white | good |
| PS3 | 85 | white | good |
| PS4 | 89 | white | good |
| PS5 | 88 | white | good |
| PS6 | 84 | white | good |
| PSV1 | 87 | brown | good |

As is clearly evident from the results specified in table 3, the inventive polymer powders PS1 to PS6 were obtained in high yields. These polymer powders also show good redispersibility properties in water and no disadvantageous discoloration like the comparative polymer powder PSV1.

4.3 Mortar Formulations

Cement based aqueous mortars were formulated using the redispersible polymer powders PS1 to PS6 and PSV1. The components and relative amounts, given in % by weight, are shown in table 4. The water/cement ratio of 0.5 was kept constant for all mortars formulated.

TABLE 4
Composition of aqueous mortar formulations

| Compounds | Amount [wt %] |
|---|---|
| Portland cement (Milke CEM I 52.5 R) | 24.37 |
| Sand (Particle size <0.08 mm) | 24.37 |
| Sand (Particle size 0.08-0.2 mm) | 24.37 |
| Sand (Particle size 0.2-0.5 mm) | 24.37 |
| Vinapor DF 9010 F⁴⁾ | 0.08 |
| Polymer powders PS1 to PS6 and PSV1 | 2.44 |
| Water | 12.19 |

⁴⁾Trademark of BASF Construction Polymers GmbH, defoamer

The formulations were prepared by first dry blending the solid compounds, as indicated in table 4, and then adding water in a second step. The aqueous mortar formulation was mixed for 2 minutes using a mixer as specified in DIN EM 196-1 operating at 600 rpm. A constant temperature of 23° C. was maintained during the mixing of the aqueous mortar formulation. Based on the polymer powders PS1 to PS6 and PSV1 used in the formulation of the mortar preparation the obtained aqueous mortar formulations are described as MPS1 to MPS6 and MPSV1.

4.4) Flow Behavior

The flow behavior of the aqueous mortar formulations MPS1 to MPS6 and MPSV1 is expressed as spread diameter on a flow table, following DIN EN 1015-3. The conical mold (600 mm height, inner diameter upper part 70 mm, lower part 100 mm) used for placing the aqueous mortar formulations MPS1 to MPS6 and MPSV1 on the flow table had the following dimensions: 600 mm height, inner diameter top 70 mm, inner diameter bottom 100 mm. The mold was filled to full height with the aqueous mortar formulation MPS1 to MPS6 and MPSV1 2, 15 and 30 minutes after adding the water to the corresponding dry mix formulations. The table was then dropped 15 times during 15 seconds upon removal of the cone. The diameter of the spread mortar formulations was measured in two perpendicular directions. All diameters given in table 5 obtained with the aqueous mortar formulations MPS1 to MPS6 and MPSV1 as well as an aqueous mortar formulation, being prepared without any polymer modification are average values. The measurements were carried out at 23° C. and a relative humidity of 50%.

TABLE 5
Slump diameters of mortars

| Mortar | Slump Diameter after | | |
|---|---|---|---|
| formulation | 2 minutes [cm] | 15 minutes [cm] | 30 minutes [cm] |
| MPS1 | 20.4 | 19.2 | 18.5 |
| MPS2 | 20.8 | 19.8 | 18.3 |
| MPS3 | 20.5 | 19.9 | 18.8 |
| MPS4 | 18.9 | 17.4 | 16.1 |
| MPS5 | 17.4 | 16.5 | 15.7 |
| MPS6 | 20.9 | 19.7 | 18.9 |
| MPSV1 | >25 | >25 | >25 |
| —⁵⁾ | 18.4 | 15.6 | 15.3 |

⁵⁾Mortar formulation being prepared without the addition of a polymer powder; the relative amounts of the other compounds according to table 4 remain unchanged

As can be derived from the results shown in table 5 the inventive polymer powders MPS1 to MPS6 based on the novel spray drying assistants S1 to S6 affected the flow behavior of the aqueous mortar formulations significantly less negatively compared to the comparative polymer powder MPSV1.

1. A process for the preparation of a readily water-redispersible polymer powder, comprising spray drying an aqueous dispersion of a polymer B (aqueous polymer B dispersion), wherein the spray drying of the aqueous polymer B dispersion is effected in the presence of a polymer A, wherein polymer A has a glass transition temperature ≧60° C., a weight average molecular weight Mw≧1000 and ≦25000 g/mol, a polydispersity index ≦5 and comprises
≧5 and ≦50 wt % of at least one α,β-monoethylenically unsaturated mono- or dicarboxylic acid and/or anhydride (monomer A1), and
≧50 and ≦95 wt % of at least one other ethylenically unsaturated compound which is copolymerizable with the monomers A1 (monomer A2),
in polymerized form, wherein the monomer amounts A1 and A2 sum up to 100 wt %.

2. The process according to claim 1, wherein polymer A comprises
≧15 and ≦30 wt % of at least one monomer A1, and
≧70 and ≦85 wt % of at least one monomer A2.

3. The process according to claim 1, wherein monomer A1 is acrylic acid and/or methacrylic acid and monomer A2 is methyl methacrylate, n-butyl acrylate, 2-ethylhexyl acrylate, styrene and/or α-methyl styrene.

4. The process according to claim 1, wherein polymer A is used in the form of an aqueous suspension or solution having a pH value of ≧7 and ≦10.

5. The process according to claim 1, wherein polymer A has a glass transition temperature of ≧80 and ≦130° C.

6. The process according to claim 1, wherein polymer A has a weight average molecular weight Mw of ≧10,000 and ≦20,000 g/mol.

7. The process according to claim 1, wherein polymer A has a polydispersity index of ≧205 and ≦4.5.

8. The process according to claim 1, wherein from 0.1 to 40 parts by weight of polymer A are used per 100 parts by weight of polymer B (solid/solid).

9. The process according to claim 1, wherein the polymer B comprises
from 50 to 99.9 wt % of esters of acrylic and/or methacrylic acid with alkanols of 1 to 12 carbon atoms and/or styrene, or
from 50 to 99.9 wt % of styrene and butadiene, or
from 50 to 99.9 wt % of vinyl chloride and/or vinylidene chloride, or
from 40 to 99.9 wt % of vinyl acetate, vinyl propionate and/or ethylene in polymerized form.

10. The process according to claim 1, wherein the polymer B has a glass transition temperature of ≧0 and ≦20° C.

11. The process according to claim 1, wherein, in addition to the polymer A, an antiblocking agent is employed for the spray drying.

12. A polymer powder obtained by the process according to claim 1.

13. A process, comprising applying a polymer powder according to claim 12 as a binder in adhesives, sealing compounds, synthetic resin renders, paper coating slips, surface coating compositions and other coating materials or as an additive in mineral binder formulations.

14. A process comprising spray drying an aqueous polymer dispersion with a polymer A, which has a glass transition temperature ≧60° C., a weight average molecular weight of Mw ≧1000 and ≦25000 g/mol, a polydispersity index of ≦5 and is composed of comprises
≧5 and ≦50 wt % of at least one monomer A1, and
≧50 and ≦95 wt % of at least one monomer A2,
in polymerized form, wherein the monomer amounts A1 and A2 sum up to 100 wt %, as a spray assistant.
